(19) United States
(12) Patent Application Publication
(10) Pub. No.: US 2026/0114965 A1
(43) Pub. Date: Apr. 30, 2026

(54) DENTAL IMPLANT RETAINING DRIVER

(71) Applicants: Dan Rosen, Sherman Oaks, CA (US); Deniss G. Smiler, Sherman Oaks, CA (US)

(72) Inventors: Dan Rosen, Sherman Oaks, CA (US); Deniss G. Smiler, Sherman Oaks, CA (US)

(21) Appl. No.: 19/432,085

(22) Filed: Dec. 23, 2025

Related U.S. Application Data
(63) Continuation-in-part of application No. 17/827,820, filed on May 30, 2022.

(51) Int. Cl. A61C 8/00

(52) U.S. Cl. CPC A61C 8/0089; A61C 8/0022

(57) ABSTRACT

A dental implant retaining driver apparatus has a body portion and an extension portion extending from the body portion. The extension portion terminating opposite the body portion in a connection region configured to engage a dental implant in a non-rotational relationship. The body portion and the extension portion together have a bore, and a retaining rod in the bore is configured to rotate relative to the body portion and the extension portion. An engagement portion on the retaining rod extends out of the extension portion. The engagement portion is configured to engage the dental implant, such that when the engagement portion and the connection region engage the dental implant, the dental implant cannot be rotated or removed from the apparatus.

### CROSS-REFERENCE TO RELATED APPLICATION

This application is a continuation-in-part of pending U.S. utility patent application Ser. No. 17/827,820, filed on May 30, 2022, the entirety of which is incorporated herein.

### BACKGROUND

### Field of the Invention

The present invention generally relates to a dental surgery apparatus. More specifically, the present invention relates to a dental implant retaining driver for retaining a dental implant on the driver.

### Related Art

Dental implant drivers are known in the art. A dental implant driver typically comprises a gripping portion and an extension portion. A dental implant is mounted on the end of the extension portion, with the dental implant threads extending away from the dental implant driver. The dental implant is mounted in a non-rotational manner. For example, the end of the extension portion may have a hexagonal circumferential profile, while the dental implant has a complimentary hexagonal inner profile, similar to a hex nut and Allen wrench in other settings.

In a conventional dental implant driver, the dental implant is mounted non-rotationally, but is able to freely disengage the dental implant driver by moving away from it (again, similar to a conventional hex nut/Allen wrench configuration). When installing a dental implant, the surgeon mounts the dental implant on the dental implant driver and rotates the threaded portion of the dental implant into the patient's bone. Once the dental implant is in place, the surgeon retracts the dental implant driver, and the dental implant remains installed.

One problem with this procedure occurs in areas with less substantial or thinner bone. In such cases, the dental implant, if improperly placed, may be irretrievably lodged in a patient, requiring further surgery. For example, when driving a dental implant into a patient's maxilla there is a risk that the implant will be inadvertently pushed too far, into the patient's maxillary sinus. In such a case, when the dental implant driver is retracted, the dental implant remains in the maxillary sinus requiring further surgery for removal.

Hence, what is needed is a dental implant driver that provides a dental implant retaining function, without the limitations of existing techniques.

### SUMMARY

A dental implant retaining driver apparatus for retaining a dental implant driven by a user into a patient's bone includes a body portion configured for a user to manually hold the apparatus. An extension portion extends from the body portion. The extension portion is preferably smaller in circumference than the body portion, for operating in small oral spaces on a patient. The extension portion preferably terminates opposite the body portion in a connection region, wherein the connection region is configured to engage the dental implant in a non-rotational relationship with the apparatus.

The body portion and the extension portion together include a bore extending through them. A retaining rod is positioned in the bore, with the retaining rod configured to rotate relative to the body portion and the extension portion (i.e., rotate within the body portion and the extension portion). An engagement portion of the retaining rod extends out of the extension portion at the end of the extension portion. The engagement portion is configured to engage the dental implant in a retaining manner, such that when the engagement portion and the connection region each engage the dental implant, the dental implant cannot be rotated or removed from the apparatus.

The apparatus also preferably includes a release knob. The release knob is coupled to the retaining rod such that the retaining rod rotates with the release knob when turned by the user. The release knob is preferably located opposite the engagement portion. The body portion may include grips, which may be indentations, configured for securing the apparatus manually and manipulating the apparatus by the user. Additionally, the extension portion may be configured to have a first length and a second length. In one implementation, the connection region may be a hex connection. In other implementations, differently shaped configurations are contemplated.

In one implementation, the extension portion includes a retaining extension portion. In other implementations, the retaining rod may have a reduced circumference where it travels through the extension portion. In various other implementations, the apparatus may be substantially 130.00 cm in length. The extension portion may be 49.8 cm in length, and the release knob may be 15 cm in height. The retaining rod may have a reduced circumference where it travels through the extension portion, and the release knob may additionally include circumferential ridges for improved gripping by the user.

### BRIEF DESCRIPTION OF THE FIGURES

FIG. 1 illustrates an elevation view of a prior art dental implant driver.

FIG. 2 illustrates the prior art dental implant driver in use on a dental patient's maxilla.

FIG. 3 illustrates a perspective view of a dental implant retaining driver according to the present disclosure.

FIG. 4 illustrates an elevation view of the dental implant retaining driver.

FIG. 5 illustrates a cut-away elevation view of the dental implant retaining driver.

FIG. 6 illustrates a cut-away elevation view of a tip of the dental implant retaining driver.

FIG. 7 illustrates a top view of the dental implant retaining driver.

### REFERENCE NUMBERS

10. conventional dental implant driver
12. body portion
14. extension portion
16. grip
18. driving body
20. dental implant
22. hex connection
24. maxilla
26. dental implant retaining driver
28. retaining extension portion
32. release knob
34. first length
36. second length
38. elongated portion
40. third length
42. height
44. bore
46. retaining rod
48. narrow portion
50. threaded portion
52. ridge
54. first width
56. second width

### DESCRIPTION

The following description is presented to enable any person skilled in the art to make and use the invention and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown but is to be accorded the widest scope consistent with the principles and features disclosed herein.

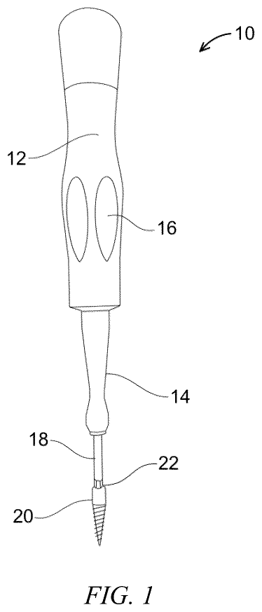

Referring to FIG. 1 a conventional dental implant driver 10 is shown. The conventional dental implant driver 10 includes a body portion 12 and an extension portion 14. The body portion 12 may include grip areas 16, which enable a more secure grip on the otherwise cylindrical dental implant driver 10. A driving body 18 extends from the extension portion 14, and the driving body 18 engages the dental implant 20. As illustrated, the driving body 18 engages the dental implant 20 in a hex connection 22, although any connection preventing rotation (square, triangular, etc.) is possible depending on a particular driver manufacturer.

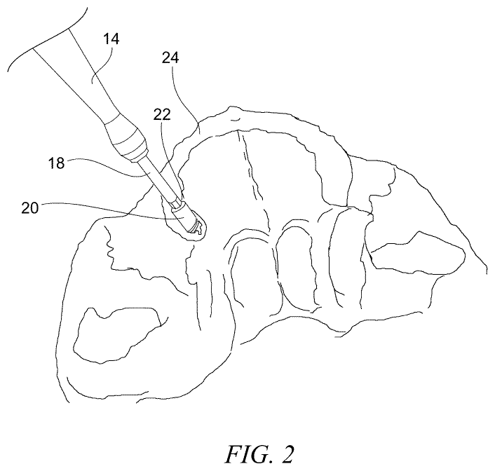

Referring to FIG. 2, the conventional dental implant driver 10 is shown installing the dental implant 20 into a patient's maxilla 24, shown from below the patient's maxilla 24 in the upper jaw region. Due to the relatively thin and shallow structure of the patient's maxilla 24, depending on the angle of the dental implant 20, there is a risk that the dental implant 20 may travel through the maxilla and lodge in a position or in a sinus (such as the maxillary sinus) in a manner such that the dental implant 20 disengages from the dental implant driver 10, and cannot be retrieved without invasive surgery.

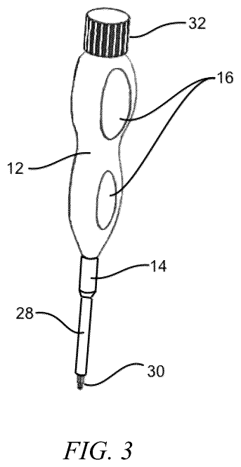

Referring to FIG. 3, an improved dental implant retaining driver 26 is shown. Similar to the conventional dental implant driver 10 (FIGS. 1 and 2), the improved dental implant retaining driver 26 includes a body portion 12 and an extension portion 14. Also similar to the conventional dental implant driver 10, the improved dental implant retaining driver 26 may include grips 16 for securely holding the dental implant retaining driver 26 when in use. Unlike the conventional dental implant driver 10, the improved dental implant retaining driver has a retaining extension portion 28 that hold a threaded portion of the retaining rod (50) in place, preventing both rotational movement, and also preventing a dental implant (not shown) from disengaging from the dental implant retaining driver 26. A release knob 32 is provided opposite the retaining extension portion 28, which allows an operator to release the threaded portion of the retaining rod 50 and the dental implant retaining driver 26 from the dental implant once installed in the proper place.

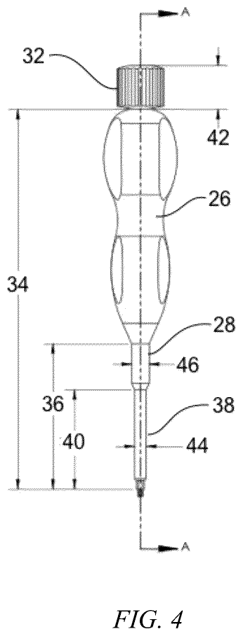

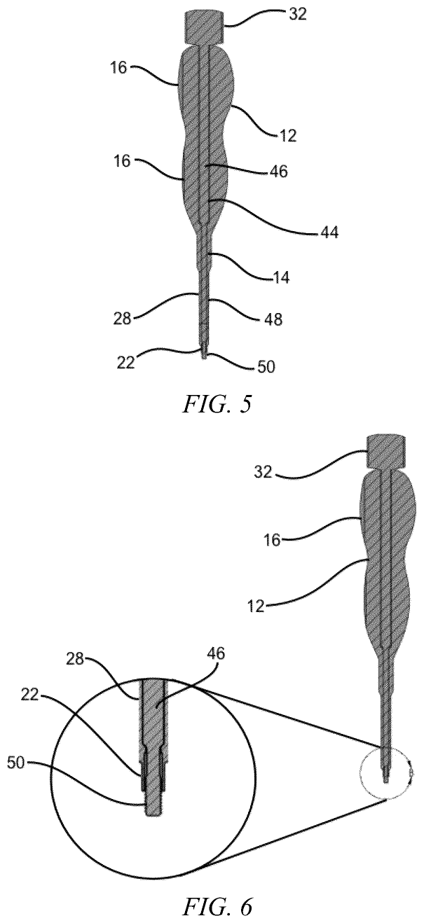

Referring to FIG. 4, in one implementation, the dental implant retaining driver 26 may have a first length 34 of 130.00 mm. The portion of the dental implant retaining driver 26 comprising the retaining extension portion 28 may have a second length 36 of 49.8 mm. The retaining extension portion 28 may have an elongated portion 38 having a third length of 34.10 mm. The release knob 32 may have a height 42 of 15.00 mm. The elongated portion 38 of the retaining extension portion 28 may have a first width 54 of 4.00 mm, while the remainder of the retaining extension portion 28 may have a second width 56 of 6.00 mm. FIG. 4 also shows cut axis A which refers to the cut-away view of FIG. 5.

Referring to FIG. 5, the dental implant retaining driver 26 is shown in a cut-away view along axis A of FIG. 4. The body portion 12 includes a bore 44 through which a retaining rod 46 passes. The retaining rod 46 is attached to the release knob 32 such that it rotates with the release knob 32 when rotated. The retaining rod 46 is configured to rotate relative to the body portion 12 and the extension portion 14 with no axial movement of the retaining rod 46 relative to the body portion 12. In an one alternative embodiment, the retaining rod 46 is limited in its movement toward the body portion 12. The retaining rod 46 also may include a narrow portion 48 which extends through the retaining extension portion 28 of the dental implant retaining driver 26. The retaining rod 46 terminates opposite the release knob 32 in a threaded portion of the retaining rod 50. In the illustrated implementation, the retaining extension portion 28 terminates in a hex connection 22 to engage a dental implant (not shown). The threaded portion of the retaining rod 50 extends past the hex connection 22 to engage the dental implant. While the hex connection 22 prevents the dental implant from rotating relative to the dental implant retaining driver 26, the threaded portion of the retaining rod 50 prevents the dental implant from disengaging the dental implant retaining driver 26 until the release knob 32 is turned, thereby rotating the retaining rod 46 and threaded portion 50, until the threaded portion of the retaining rod 50 disengages the dental implant.

Referring to FIG. 6, the tip of the dental implant retaining driver 26 is shown in close-up cut-away view to better illustrate its operation. The retaining rod 46 extends out of the retaining extension portion 28, terminating in the threaded portion of the retaining rod 50. The end of the extension portion 28 comprises the hex connection 22, in which the outer circumference of the extension portion 28 comprises a hexagonal series of facets around its circumference. A dental implant (not shown) designed to engage the dental implant retaining driver 26 will be complimentary, such that the hex connection 22 extends into the dental implant, preventing it from turning, and the threaded portion of the retaining rod 50 rotates into the dental implant, preventing it from disengaging the dental implant retaining driver 26.

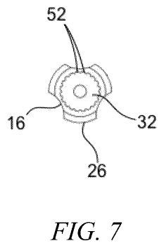

Referring to FIG. 7, the top of the dental implant retaining driver 26 is shown, including the release knob 32. The release knob 32 preferably includes ridges 52, enabling the user to more easily rotate the retaining rod 46 (FIG. 6), and thereby engage or release the dental implant (not shown). In this view, the grips 16 for rotating the dental implant retaining driver 26 can also be seen more clearly.

In order to use the dental implant retaining driver 26, a user places a dental implant 20 (FIGS. 1 and 2) on the hex connection 22 of the dental implant retaining driver 26. The user may then rotate the release knob 32 in a first direction, such that the threaded portion of the retaining rod 50 engages the dental implant 20. The dental implant may be then driven into a patient's bone. If the dental implant perforates the bone into a sinus or other improper location, the user may remove the dental implant without the risk of it disengaging the dental implant retaining driver 26. Once the dental implant is in place, the release knob 32 may be rotated in a second direction, such that the threaded portion of the retaining rod 50 disengages the dental implant 20. The dental implant retaining driver 26 can then be disengaged from the dental implant by retracting the hex connection 22 out of the dental implant.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A dental implant retaining driver apparatus for retaining a dental implant driven by a user into a patient's bone, the apparatus consisting of:
a body portion configured for manually holding by the user;
an extension portion extending from the body portion, the extension portion smaller in circumference than the body portion;
a retaining extension portion adapted to hold a threaded portion of a retaining rod in place to prevent rotational movement relative to each other, and to prevent a dental implant from disengaging from the dental implant retaining driver;
the body portion, the extension portion and the retaining extension portion together comprising a bore therethrough;
the retaining rod in the bore, the retaining rod configured to rotate relative to the body portion and the extension portion with no axial movement of the retaining rod relative to the body portion;
the retaining rod increases in circumference at an upper end to form a release knob outside the body portion that rotates with the retaining rod; and said retaining rod decreases in circumference in the vicinity of the extension portion and decreases further in circumference at the vicinity of the hex connection, with the interior surface of the bore matching the circumference at said vicinities;
the retaining rod terminates opposite the release knob in a threaded portion of the retaining rod;
the retaining extension portion terminates in a hex connection to engage the dental implant; and
the threaded portion of the retaining rod extends past the hex connection to engage the dental implant;
wherein, while the hex connection prevents the dental implant from rotating relative to the dental implant retaining driver, the threaded portion of the retaining rod prevents the dental implant from disengaging the dental implant retaining driver until the release knob is turned, thereby retaining the retaining rod and threaded portion of the retaining rod until the threaded portion of the retaining rod disengages the dental implant.

2. The apparatus of claim 1 further comprising grips on the body portion, the grips configured for securing the apparatus manually by the user.

3. The apparatus of claim 1 wherein the apparatus is 130.00 cm in length.

4. The apparatus of claim 1 wherein the extension portion is 49.8 cm in length

5. The apparatus of claim 1 wherein the release knob is 15 cm in height.

6. The apparatus of claim 1 wherein the release knob further comprises circumferential ridges for improved gripping by the user.
